(19) United States
(12) Patent Application Publication
(10) Pub. No.: US 2011/0169222 A1
(43) Pub. Date: Jul. 14, 2011

(54) GAME TABLE HAVING SOUND-AMPLIFYING EFFECT

(76) Inventor: Shu-Chuan LIAO, Taipei (TW)

(21) Appl. No.: 12/685,094

(22) Filed: Jan. 11, 2010

(51) Int. Cl. A63F 9/00; H04R 1/02

(52) U.S. Cl. 273/309; 381/386

(57) ABSTRACT

A game table having sound-amplifying effect includes a board, a plurality of supporting legs, and at least one speaker. The supporting legs are connected to the bottom of the board respectively. One of the supporting legs is provided therein with a resonating chamber. The speaker is received in the resonating chamber. With this arrangement, the sound generated by the speaker received within the supporting leg can be amplified by the resonating chamber to generate a uniform and powerful sound effect. Further, the speaker is received within the supporting leg and well protected without suffering damage easily.

### BACKGROUND OF THE INVENTION

1. Field of the Invention

The present invention relates to a game table, and in particular to a game table having sound-amplifying effect.

2. Description of Prior Art

With the advancement of science and technology, various kinds of game tables are developed, so that people can use these game tables for relaxation. For example, there is a popular game table, on which air hockey, soccer, basketball or baseball games can be played. With this arrangement, ball sports become funny games which can be played by one person competing against an opponent computer or another player.

Taiwan Patent No. M316752 discloses an air hockey game table capable of playing music. The air hockey game table includes a board defining a playing surface, legs supporting the board, two goal areas provided on the playing surface, and a score display disposed over the board. Pushers and a puck are disposed on the board. The score display is provided with a screen. The rear end of the score display is provided with a support and a battery-receiving portion. The battery-receiving portion is provided with an input hole and both sides thereof are electrically connected with a speaker respectively. The score display is connected to a music player by means of transmission lines, so that the score display can display the immediate scores and playing music.

However, in practice, the above-mentioned game table has some problems as follows. Since the speakers are disposed on the board without any sound boxes for amplifying the sound, the sound generated by the speaker directly spreads to external air without any resonation. There, the sound is not powerful enough. On the other hand, the speakers are exposed to the surface of the board. This may affect the external appearance of the game table and the speakers may suffer damage easily.

In view of the above, the present inventor proposes a reasonable structure based on his expert experience and deliberate researches.

### SUMMARY OF THE INVENTION

The present invention is to provide a game table having sound-amplifying effect, which is capable of generate a uniform and powerful sound with a good external appearance.

The present invention is to provide a game table having sound-amplifying effect, which includes a board; a plurality of supporting legs connected to a bottom of the board, one of the supporting legs being provided therein with a resonating chamber; and at least one speaker disposed in the resonating chamber.

In comparison with prior art, the present invention has advantages as follows.

According to the game table of the present invention, since the interior of the supporting leg is provided with a resonating chamber and a speaker is disposed in the resonating chamber, the sound generated by the speaker can be amplified by the resonating chamber. The amplified sound then propagates from the top of the resonating chamber toward the board, thereby generating a uniform and powerful sound effect.

Further, according to the present invention, since the speaker is disposed in the supporting leg without being exposed to the upper surface of the board, the external appearance of the game table will not be affected by the speaker. In addition, the speaker can be well protected in the resonating chamber of the supporting leg without suffering damage easily.

### BRIEF DESCRIPTION OF THE DRAWINGS

FIG. 1 is an exploded perspective view of the present invention;

FIG. 2 is an assembled perspective view of the present invention;

FIG. 3 is an assembled top view of the present invention;

FIG. 4 is a cross-sectional view taken along the line 4-4 in FIG. 3;

FIG. 5 is a cross-sectional view similar to FIG. 4, which shows the propagation of sound; and

FIG. 6 is a perspective view showing an embodiment of the present invention.

### DETAILED DESCRIPTION OF THE INVENTION

The characteristics and technical contents of the present invention will be described with reference to the accompanying drawings. However, the drawings are illustrative only but not used to limit the present invention.

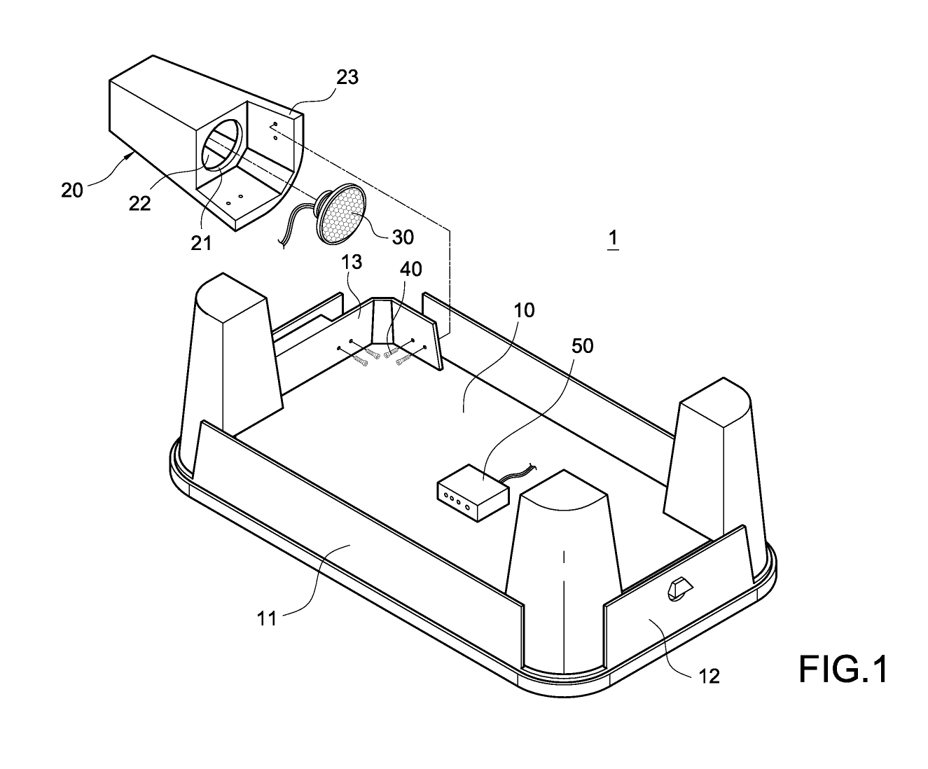

Please refer to FIG. 1, which 1 is an exploded perspective view of the present invention. The present invention provides a game table having sound-amplifying effect. The game table 1 includes a board 10, four supporting legs 20, and two speakers 30.

The board 10 is a rectangular plate. The lower edges of the board 10 extend to form a plurality of side plates 11 and 12 respectively. In the embodiment shown in FIG. 1, the side plates 11 are located on the long sides of the board 10, and the side plates 12 are located on the short sides of the board 10. The side plates 11 and 12 are not connected with each other, and an interval is formed between the side plates 11 and 12 at four corners of the board 10 respectively. Further, the lower surface of the board 10 is provided with a plurality of partitioning plates 13 parallel to the side plates 11 and 12 respectively. Each of the partitioning plates 13 is substantially formed into an L shape, whereby the supporting legs 20 can be assembled with the board 10 easily.

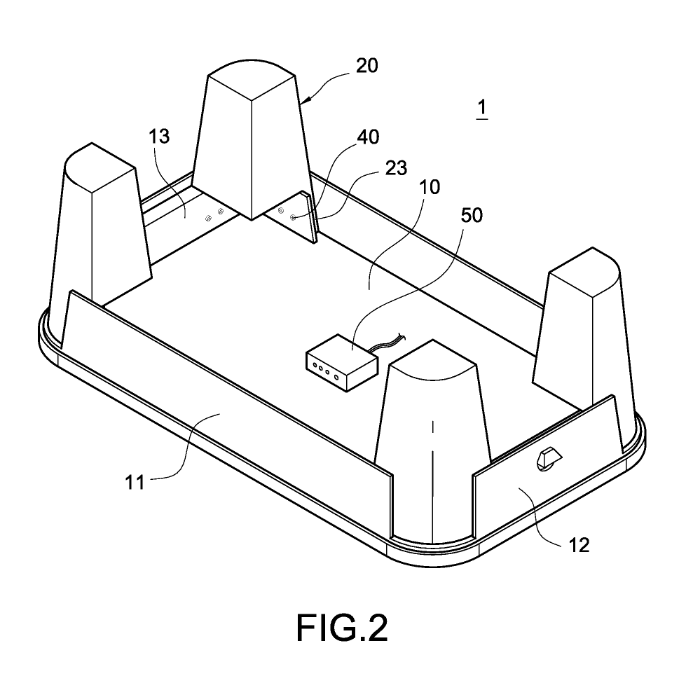

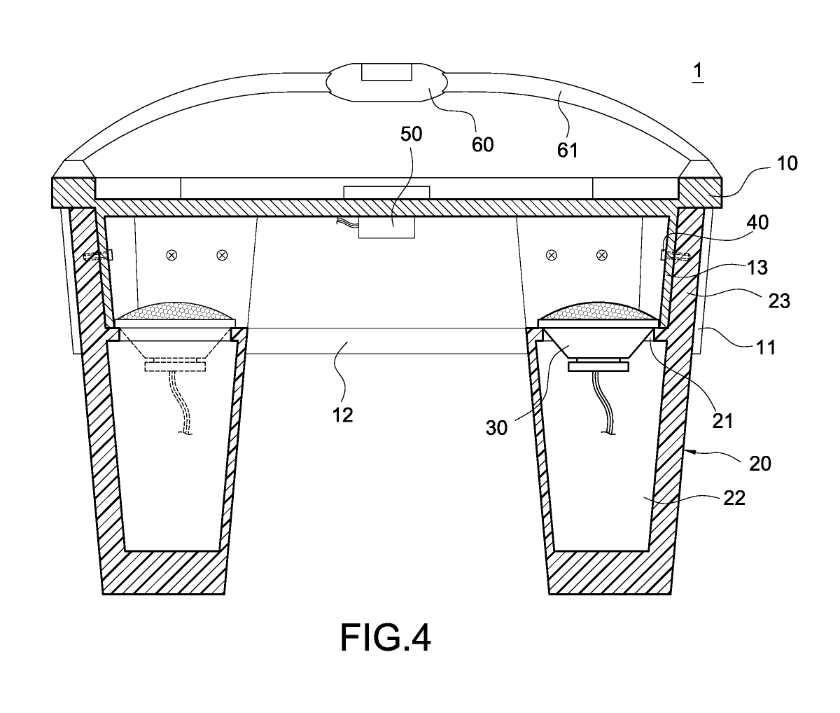

Each of the supporting legs 20 is shaped as a pillar with a sector-like cross section, and the shape of the supporting leg 20 is not limited thereto. The top surface 20 of the supporting leg 20 has a circular opening 21. The interior of the supporting leg 20 forms a hollow resonating chamber 22 (FIG. 4). In order to assemble the supporting legs 20 with the four corners of the board 10 more easily, the top of each supporting leg 20 extends upwards to form two adjacent mounting plates 23. With bolts 40 penetrating the L-shaped partitioning plate 13 and the mounting plates 23, the supporting leg 20 can be fixed to one corner of the board 10. FIG. 2 shows that four supporting legs 20 are assembled with four corners of the board 10 respectively to obtain the game table 1 of the present invention.

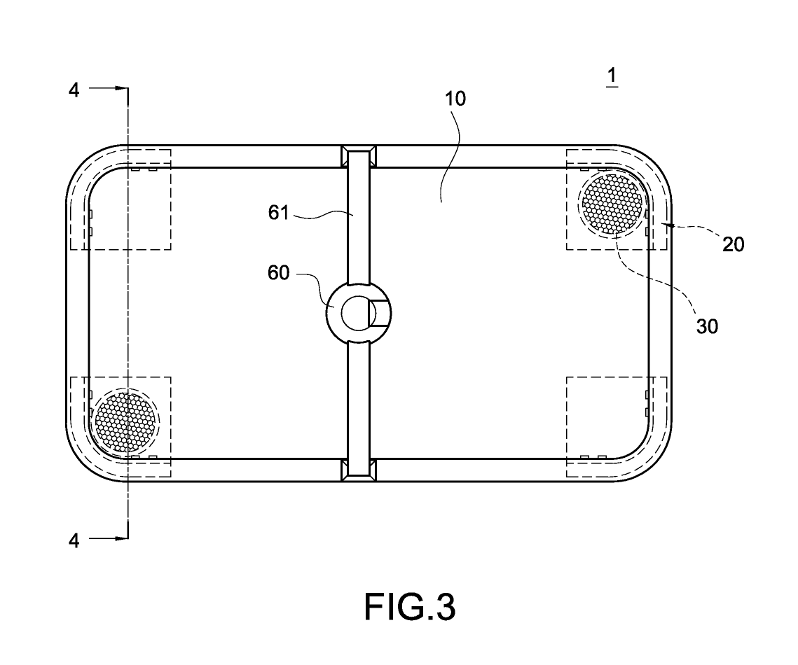

The speaker 30 is supported on the opening 21 (FIG. 4) of the supporting leg 20. In the present embodiment, as shown in FIG. 3, there are two speakers 30 located on both ends of one diagonal line of the board 10. However, the number of the speakers 30 is not limited thereto and can be increased according to practical demands.

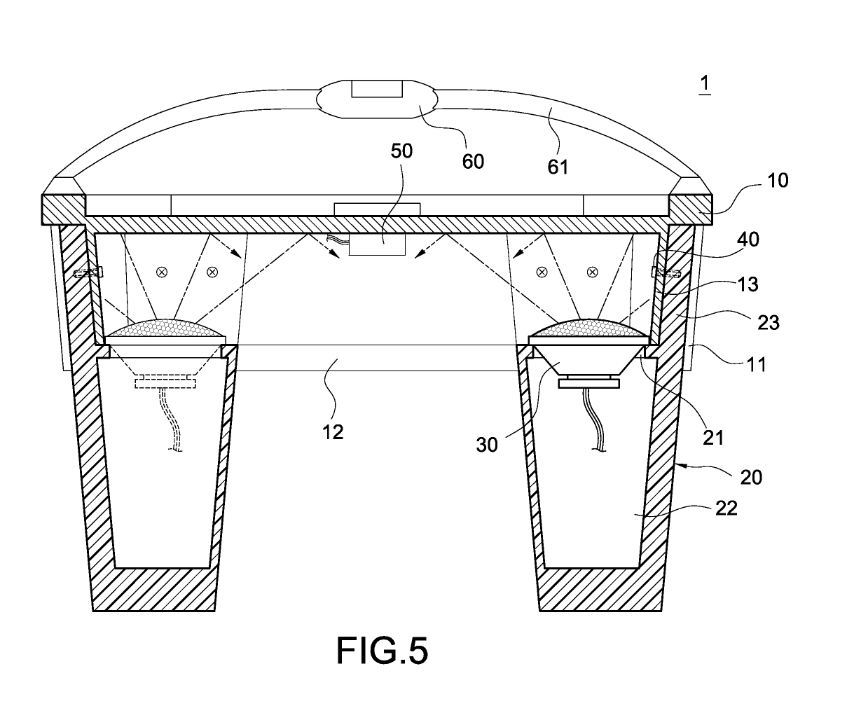

Please refer to FIGS. 4 and 5. As shown in these figures, since the top of the supporting leg 20 extends upwards to form the mounting plates 23, a distance is formed between the speaker 30 supported on the opening 21 of the supporting leg 20 and the lower surface of the board 10. Thus, the sound generated by the speaker 30 can be amplified in the resonating chamber 22 of the supporting leg 20 and then propagate toward the lower surface of the board 10. Since the lower edges of the board 10 has the side plates 11 and 12, the sound generated by the speaker 30 may not spread outside the board 10 easily but concentrate on the center of the lower surface of the board 10, thereby generating a uniform and powerful sound effect.

Further, according to the present invention, the lower surface of the board 10 is mounted with a music player 50 that is electrically connected to the speaker 30. With this music player 50, when using the game table 1, a user can listen to favorite music at the same time.

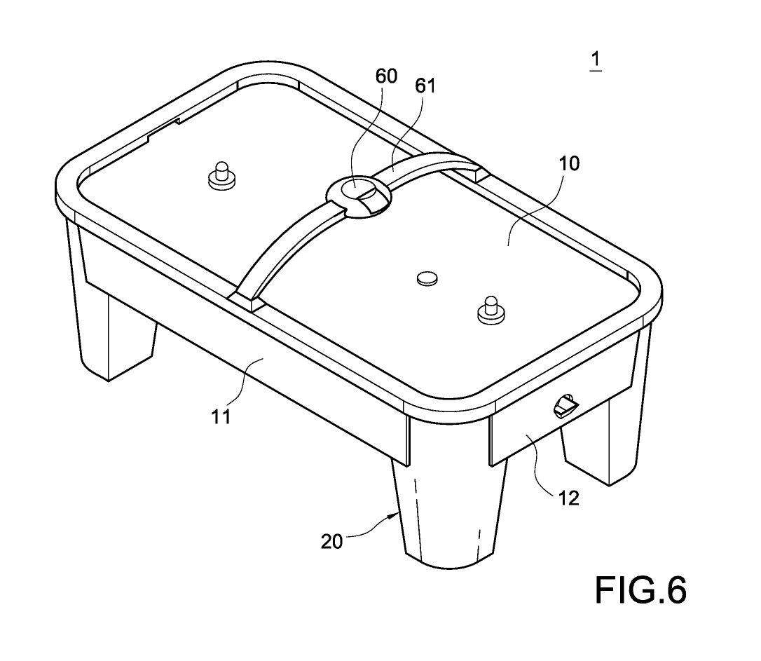

Please refer to FIG. 6. According to the present embodiment, the game table 1 is used for an air hockey game. The upper surface of the board 10 is provided with a score display 60 and two arms 61 for fixedly connecting the score display 60 to the board 10. The upper surface of the board 10 is used as a playing surface, on which patterns or materials associated with the game can be provided. FIG. 6 shows that two pushers and a puck are disposed on the board 10.

The characteristic of the game table 1 of the present invention lies in that: the supporting leg 20 is hollowed for receiving the speaker 30 therein, so that the inner space (i.e., the resonating chamber 22) of the supporting leg 20 can be used for amplifying the sound. Then, the amplified sound propagates from the top of the supporting leg 20 toward the lower surface of the board 10, thereby generating a uniform and powerful sound effect.

On the other hand, since the speaker 30 is received within the supporting leg 20 without being exposed to the upper surface of the board 10 or outside the side plate 11, 12, the external appearance of the game table 1 may not be affected by the speakers 30. Further, the speaker 30 can be well protected by receiving in the supporting leg 20.

Incidentally, although the game table of the present invention is used for an air hockey game in the above description, it should be noted that the game table 1 of the present invention can be also applied to other games, such as baseball, soccer, table tennis, basketball, or billiards.

According to the above, the present invention really demonstrates industrial applicability, novelty and inventive steps. Further, the construction of the present invention has not be seen in products of the same kinds or let in public use. Therefore, the present invention conforms to the requirements for an invention patent

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A game table having sound-amplifying effect, including:
a board;
a plurality of supporting legs connected to a bottom of the board, one of the supporting legs being provided therein with a resonating chamber; and
at least one speaker received in the resonating chamber.

2. The game table having sound-amplifying effect according to claim 1, wherein lower edges of the board extend downwards to form a plurality of side plates for connecting to the supporting legs.

3. The game table having sound-amplifying effect according to claim 1, wherein a lower surface of the board extends to form a plurality of partitioning plates for assembly with the supporting legs.

4. The game table having sound-amplifying effect according to claim 3, wherein a top of each supporting leg extends to form a mounting plate for assembly with the partitioning plate.

5. The game table having sound-amplifying effect according to claim 1, wherein each of the supporting legs has an opening above the resonating chamber for supporting the speaker.

6. The game table having sound-amplifying effect according to claim 1, further including a music player electrically connected to the speaker.

7. The game table having sound-amplifying effect according to claim 1, further including a score display located above the board and two arms for fixedly connecting the score board to the board.
